(19) United States
(12) Patent Application Publication
(10) Pub. No.: US 2008/0054659 A1
(43) Pub. Date: Mar. 6, 2008

(54) Shovel with depth measuring increments

(76) Inventor: Jason Aaron Boxum, Albuquerque, NM (US)

Correspondence Address: JASON BOXUM, 9720 RIO GRANDE, ALBUQUERQUE, NM, 87114, US

(21) Appl. No.: 11/895,059

(22) Filed: Aug. 23, 2007

Related U.S. Application Data
(60) Provisional application No. 60/824,676, filed on Sep. 6, 2006.

(51) Int. Cl. A01B 1/20

(52) U.S. Cl. 294/51

(57) ABSTRACT

One embodiment of a shovel with depth measuring increments is an implement that includes increments (1) of inches, feet, centimeters, and meters along a handle (2) and a blade (3). This unique shovel is constructed so that indicia extend along the vertical positioning of the implement from the tip of the blade to the top of the handle. The blade and the handle both have indicia clearly marked. Other embodiments are described and shown.

### CROSS-REFERENCE TO RELATED APPLICATIONS

This application claims the benefit of provisional patent application Ser. No. 60/824,676, filed 2006 Sep. 06 by the present inventor.

### FEDERALLY SPONSORED RESEARCH

Not Applicable

### SEQUENCE LISTING OR PROGRAM

Not Applicable

### BACKGROUND—FIELD OF INVESTIGATION

This invention relates to a hand tool that can be used dig holes in a work place and simultaneously make depth-measuring increments available to the digging person. This improved shovel include depth-measuring increments that are marked along the vertical direction of the blade and handle.

### BACKGROUND PRIOR ART

Originally shovels were made with a flat blade and a long handle. This design was ideal for digging holes but also required the use of an additional apparatus in order to measure the depth of the hole.

Workers are accustomed to using an additional measuring implement in order for them to measure the depth of the hole being worked upon, thereby making the process more complicated and time consuming.

Thereafter, a graduated handle was designed that attached to a shovel blade but failed to include the benefit of a graduated blade. U.S. patent application Ser. No. 08/816,187 was issued to Marcus (1997) discloses a complex incremented handle that indicated the depth of a hole; this handle however failed to indicate the depth of a hole below the height of the shovel blade.

Thus if the depth of a hole is below the blade's height, the handle doesn't solve the problem of measuring the depth of a small hole.

This made digging a specified depth equally as challenging as it also required a separate measuring apparatus to determine the depth of a hole being worked upon.

My own improved shovel also provides the benefit of measuring the full depth of a hole being worked in inches, feet, centimeters, and meters. This improvement to a shovel also allows workers to use schematics without a conversion factor.

The importance of having centimeters, meters, inches, and feet relates to the schematic that a worker may be using. Civil Engineers typically use units of centimeters and meters where CAD drafters typically indicate inches and feet when drawing blueprints or architectural drawings. My improved shovel allows workers to dig holes and measure the depth with accuracy and ease, regardless of how small the depth of a hole is being worked on.

### SUMMARY

In accordance with one embodiment an improved depth measuring shovel comprises a long incremented handle and an incremented blade.

### DRAWINGS—FIGURES

FIG. 1 shows the full view of the Improved Depth Measuring Shovel.

### DRAWINGS—REFERENCE NUMERALS

1. Increments

2. Incremented Handle

3. Incremented Blade.

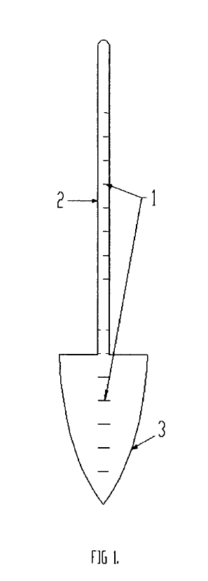

### DETAILED DESCRIPTION—FIG. 1.—PREFERRED EMBODIMENT

One embodiment of the improved shovel is illustrated in FIG. 1. The shovel has a long handle 2 and a blade 3 that clearly indicate the depth of a hole being worked on by the indicia 1 located along the vertical position of the improved shovel.

In the preferred embodiment, improved shovel with depth measuring increments can be constructed of any tool handle material, including, but not limited to, solid wood, composite, plastic, fiberglass, or other similarly strong rigid materials.

In the preferred embodiment, the shovel blade may be constructed of an alloy, metal composite, or other strong rigid material. The shape of the blade may be curved or flat, so as long as the blade has a solid construction and no moving parts. This is important to the structural integrity of the shovel's construction. The incremented handle and the incremented blade may be connected to each other by means of screwing, pinning, or but not limited to, a locking mechanism that will maintain the structural integrity of the shovel.

In the preferred embodiment, indicia are colored so that its contrast with the color of the handle and blade make it easily visible to worker. This includes the circumference of the handle and on a single or both sides of the blade.

### Advantages

From the foregoing description, it will be easily recognized that an improved shovel with depth measuring increments advantages over the prior art that has been mentioned above. Specifically, the improved shovel with depth measuring increments is a unique implement having graduations for indicating inches, feet, centimeters, and meters, which are easily viewed around the circumference of the handle and clearly indicated on a single or both sides of the shovel blade. The ease of using this improved shovel makes digging holes of an exact size much easier with less effort. Further, the improved shovel with depth measuring increments includes indicia that begin at the sharp end of the surface of the shovel's blade and continues upward toward, but not limited to, a length less than the height of the shovel. This provides more accuracy and quicker measurements when digging smaller holes.

Referring to FIG. 1, improved shovel with depth measuring increments is shown, as those skilled in landscaping and construction or yard work will appreciate, is useful for digging small holes for plants, small waterfalls, or other miscellaneous landscaping applications that require specific dimensions. There are many other uses of my improved shovel and the foregoing is mentioned as an example of one such use. This tool is an original idea that eases the process of digging holes. As mentioned above, the shovel's unique design allows a user to easily determine the depth of a hole, specifically one that may or may not have the depth of the shovel blade.

Although the description above contains much specificity, these should not be construed as limiting the scope of the embodiment but as merely providing illustrations of some of the presently preferred embodiments. For example, the blade can have a multitude of shapes, such as square, flat, round, oval, etc.

Thus the scope of the embodiment should be determined by the appended claims and their legal equivalents, rather than by the example given.

I claim:

1.) A shovel comprising a grabbing means for manipulating the shovel; a shoveling means attached to one end of the grabbing means for digging and moving material; and graduated markings along the entire length of the grabbing means and shoveling means, wherein a user can accurately and quickly determine the depth of a hole.

2.) The shovel as set forth in claim 1, further comprising a handle attached to the grabbing means at an end opposite to that of where the shoveling means is attached.

3.) The shovel as set forth in claim 1, wherein the graduated markings are set forth as a metric measuring system including centimeters and meters.

4.) The shovel as set forth in claim 1, wherein the graduated markings are set forth as an English measuring system including inches and feet.

5.) The shovel as set forth in claim 1, wherein the grabbing means is an elongated shaft.

6.) The shovel as set forth in claim 1, wherein the shoveling means is a spade-shaped blade.

7.) A tool comprising at least one shaft for manipulating the tool; a digging member attached to one end of the at least one shaft for digging and moving material; and graduated markings along the entire length of the at least one shaft and digging member, wherein a user can accurately and quickly determine the depth of any hole or material.

8.) The tool as set forth in claim 7, further comprising a handle attached to the shaft at an end opposite to that of where the digging member is attached.

9.) The tool as set forth in claim 7, wherein the graduated markings are set forth as a metric measuring system including centimeters and meters.

10.) The tool as set forth in claim 7, wherein the graduated markings are set forth as an English measuring system including inches and feet.

11.) The tool as set forth in claim 7, wherein the shaft is elongated.

12.) The tool as set forth in claim 7, wherein the digging member is a spade-shaped blade.

13.) A depth measuring system including a shaft; a blade member attached to one end of the shaft; and graduated markings along a portion of the length of the shaft and the blade member, wherein a user can accurately and quickly determine the dimensions of any hole or material.

14.) The system as set forth in claim 13, further comprising a handle attached to the shaft at an end opposite to that of where the blade member is attached.

15.) The system as set forth in claim 13, wherein the graduated markings are set forth as a metric measuring system including centimeters and meters.

16.) The system as set forth in claim 13, wherein the graduated markings are set forth as an English measuring system including inches and feet.

17.) The system as set forth in claim 13, wherein the shaft is elongated.

18.) The system as set forth in claim 13, wherein the blade member is spade-shaped.

19.) The system as set forth in claim 13, wherein the graduated markings are along the entire length of the shaft and the blade member.
